(19) United States
(12) Patent Application Publication
(10) Pub. No.: US 2025/0200655 A1
(43) Pub. Date: Jun. 19, 2025

(54) CREDIT ISSUANCE SYSTEM, PRODUCT USAGE HISTORY TRANSMISSION APPARATUS, CREDIT ISSUANCE METHOD, AND PROGRAM

(71) Applicant: NEC Corporation, Minato-ku, Tokyo (JP)

(72) Inventors: Shinichi TORIYAMA, Tokyo (JP); Satoshi KINOSHITA, Tokyo (JP)

(73) Assignee: NEC Corporation, Minato-ku, Tokyo (JP)

(21) Appl. No.: 18/848,959

(22) PCT Filed: Mar. 25, 2022
(86) PCT No.: PCT/JP2022/014520

§ 371 Date: Sep. 20, 2024

(51) Int. Cl. G06Q 40/03; G06Q 30/018

(52) U.S. Cl. CPC G06Q 40/03; G06Q 30/018

(57) ABSTRACT

A credit issuance system, includes: a product information transmission apparatus which transmits product information of a product via a network to a blockchain; a product usage history transmission apparatus which automatically transmits a usage history of the product via the network to the blockchain; and a credit issuance apparatus which verifies the product information of the product registered in the blockchain and the usage history of the product registered in the blockchain, via the network, issues a credit used for a carbon offset based on the verified usage history, generates a certificate including the credit, and transmits the certificate to the blockchain, wherein the blockchain generates a block when the blockchain receives the product information of the product, the usage history of the product, or the certificate, and registers same in the blockchain.

### TECHNICAL FIELD

The present invention relates to a credit issuance system, a product usage history transmission apparatus, a credit issuance method, and a program.

### BACKGROUND ART

Patent Literature (PTL) 1 relates to an electricity trading system which mediates electricity trading between a first user who sells electricity and a second user who buys electricity.

PTL 2 relates to a securitization system of an environmental added value in which even a small green power generation company can trade a securitized environmental value on a network by a small unit with a consumer.

PTL 3 relates to a securities management apparatus which reduces a time required to issue a non-fossil certificate and safely manages the non-fossil certificate.

PTL 4 relates to a power trade mediating apparatus which can provide a potential buyer with an environmental value, electric power, or both of them.

PTL 5 relates to an emission right management system which determines an operator to be business supported, identify a financial institution which finances the operator determined to be business supported and easily realizes an emission right transaction

Non-Patent Literature (NPL) 1 relates to a J-credit system.

NPL 2 relates to Bitcoin.

As described in NPL 1, a J-credit system in which the country certifies emmision or absorption of a greenhouse gas as a credit is operated.

Furthermore, for example, in a blockchain such as Bitcoin described in NPL 2, a block is made up by aggregating transactions and including a hash value of a block header of a preceding block in a block header of the present block, whereby data in blocks on the blockchain becomes to be impossible to rewrite, whereby a ledger is managed on the blockchain.

A block added to a blockchain approved by the blockchain is determined by a consensus building function such as Proof of Work (PoW) and so on by each of block generation nodes connected via a Peer to Peer (P2P) network.

### CITATION LIST

### Patent Literature

PTL 1: Japanese Patent No: 6945213
PTL 2: Japanese Patent Kohyo Publication No: 2019-028827A
PTL 3: Japanese Patent Kokai Publication No: 2020-027340A
PTL 4: Japanese Patent Kokai Publication No: 2022-018463A
PTL 5: Japanese Patent No: 6625298

### Non-Patent Literature

NPL 1: “J-credit system home page (https://japancredit.go.jp)”, [online] [searched on Mar. 4, 2022, internet <URL: https://japancredit.go.jp>
NPL 2: S. Nakamoto, “Bitcoin: A Peer-to-peer Electronic Cash System” [online] [searched on Mar. 2, 2022, internet <URL: https://bitcoin.org/bitcoin.pdf>

### SUMMARY

### Technical Problem

The following analysis has been given by the present invention.

As described in NPL 1, a lot of operation is required to certificate a credit used for carbon offset (hereinafter referred to “a credit”), such as for example a J-credit. Therefore, it is difficult for ordinally people to easily utilize a credit in small lot.

It is an object of the present invention to provide a credit issuance system, a product usage history transmission apparatus, a credit issuance method, and a program which contribute to be able to easily utilize a credit in small lot.

### Solution to Problem

According to a first aspect of the present invention, there is provided a credit issuance system, including:
a product information transmission apparatus which transmits product information of a product via a network to a blockchain;
a product usage history transmission apparatus which automatically transmits a usage history of the product via the network to the blockchain; and
a credit issuance apparatus which verifies the product information of the product registered in the blockchain and the usage history of the product registered in the blockchain, via the network, issues a credit used for a carbon offset based on the verified usage history, generates a certificate including the credit, and transmits the certificate to the blockchain,
wherein the blockchain generates a block when the blockchain receives the product information of the product, the usage history of the product, or the certificate, and registers the block in the blockchain.

According to a second aspect of the present invention, there is provided a product usage history transmission apparatus which transmits usage history of a product to a blockchain via a network.

According to a third aspect of the present invention, there is provided a credit issuance method, comprising:
a step of transmitting product information of a product via a network to a blockchain, by a product information transmission apparatus;
a step of generating a block when the product information of the product is received and registering the block in the blockchain, by the blockchain;
a step of automatically transmitting a usage history of the product via the network to the blockchain, by a product usage history transmission apparatus;
a step of generating a block when the usage history of the product is received and registering the block in the blockchain, by the blockchain; a step of verifying the product information of the product registered in the blockchain and the usage history of the product registered in the blockchain, via the network, issuing a credit used for a carbon offset based on the verified usage history, generating a certificate including the credit, and transmitting the certificate to the blockchain, by a credit issuance apparatus, and
a step of generating a block when the certificate is received and registers the block in the blockchain, by the block chain.

According to a fourth aspect of the present invention, there is provided a program which causes a computer included in a product usage history transmission apparatus to perform a processing of: transmitting a usage history of a product to blockchain via a network. Note, this program can be recorded in a computer-readable storage medium. The storage medium can be non-transitory one, such as a semiconductor memory, a hard disk, a magnetic recording medium, an optical recording medium, and so on. The present invention can be realized by a computer program product.

### Advantageous Effects of Invention

According to the present invention, it is possible to provide a credit issuance system, a product usage history transmission apparatus, a credit issuance method, and a program which contribute to be able to easily utilize a credit in small lot.

### BRIEF DESCRIPTION OF DRAWINGS

FIG. 1 is a diagram illustrating an example of an outline of a configuration of a credit issuance system according to an example embodiment of the present invention.

FIG. 2 is a diagram illustrating an example of an outline of a configuration of a credit issuance system according to a first example embodiment of the present invention.

FIG. 3 is a diagram illustrating an example of an operation of a block generation part of a blockchain according to the first example embodiment of the present invention.

FIG. 4 is a flow chart illustrating an example of an outline of an operation of a credit issuance system according to the first example embodiment of the present invention.

FIG. 5 is a diagram illustrating an example of a configuration of a product usage history transmission apparatus according to a second example embodiment of the present invention.

FIG. 6 is a diagram illustrating an example of a configuration of a product usage history transmission apparatus according to a third example embodiment of the present invention.

FIG. 7 is a diagram illustrating an example of a configuration of a product usage history transmission apparatus according to a fourth example embodiment of the present invention.

FIG. 8 is a diagram illustrating a configuration of a computer which can make up a product usage history transmission apparatus of the present invention.

### DETAILED DESCRIPTION

First, an outline of an example embodiment of the present invention will be described with reference to drawings. Note, in the following outline, reference signs of the drawings are denoted to each element as an example for the sake of convenience to facilitate understanding, however, the present invention is not limited thereto. An individual connection line between blocks in the drawings, etc., referred to in the following description includes both one-way and two-way directions. A one-way arrow schematically illustrates a principal signal (data) flow and does not exclude bidirectionality.

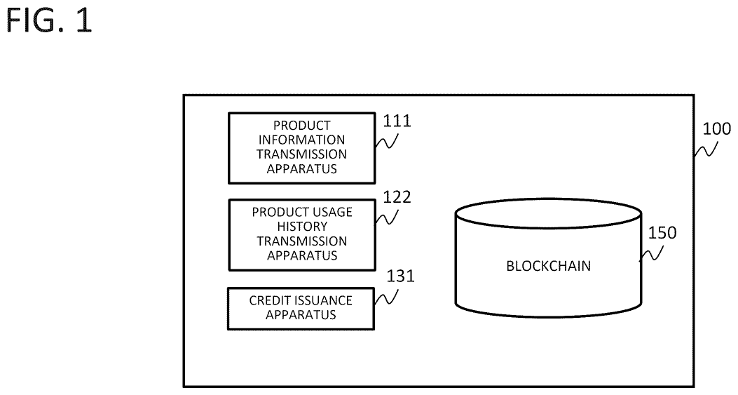

FIG. 1 is a diagram illustrating an example of an outline of a configuration of a credit issuance system according to an example embodiment of the present invention. With reference to FIG. 1, a credit issuance system 100 includes a product information transmission apparatus 111, a product usage history transmission apparatus 122, a credit issuance apparatus 131, and a blockchain 150. The blockchain 150 may be a distributed ledger.

The product information transmission apparatus 111 transmits product information of a product via a network to the blockchain 150. The blockchain 150 generates a block when the blockchain 150 receives the product information of the product, and registers the block in the blockchain 150. For example, the product information may include a specification related to emission reduction of green gas of the product, a serial number of the product, and information of an owner of the product. Note, a product may be household appliances, such as an air-conditioner, a refrigerator, a washing machine, a television set, lighting equipment, and so on, a personal computer, an electric vehicle, or the like.

The product usage history transmission apparatus 122 automatically transmits a usage history of the product via the network to the blockchain 150. The blockchain 150 generates a block when the blockchain 150 receives the usage history of the product, and registers the block in the blockchain 150. For example, the usage history of the product may include a product use state, a product use time and a serial number of the product. When an amount of emission reduction of green gas due to introduction of the product is prescribed in a product specification of a product, the product usage history of the product may not include a product use state but may include a product use time and a serial number of the product.

The credit issuance apparatus 131 verifies the product information of the product registered in the blockchain 150 and the usage history of the product registered in the blockchain 150, via the network, issues a credit based on the verified usage history, and transmits the certificate including the credit to the blockchain 150. The blockchain 150 generates a block when the blockchain receives the certificate and registers the block in the blockchain 150. Furthermore, the certificate may include the credit, a serial number of the product, and a hash value (or a digital signature) thereof. Furthermore, the certificate may include the credit, a serial number of the product, an owner information of a product and a hash value (or a digital signature) thereof. Note, as an example, the credit may be a J-credit.

Because the blockchain 150 registers product information of the product, usage history of the product and a certificate including a credit as a blockchain which is difficult to be falsified, anyone who can access the blockchain 150 is able to easily access a credit which is certified by a certification that is difficult to be falsified registered in the blockchain 150.

As a result, according to the example embodiment of the present invention, it is possible to provide a credit issuance system 100 which contributes to be able to easily utilize a credit in small lot which is issued by verifying usage history of using a product by a user who bought a product.

### First Example Embodiment

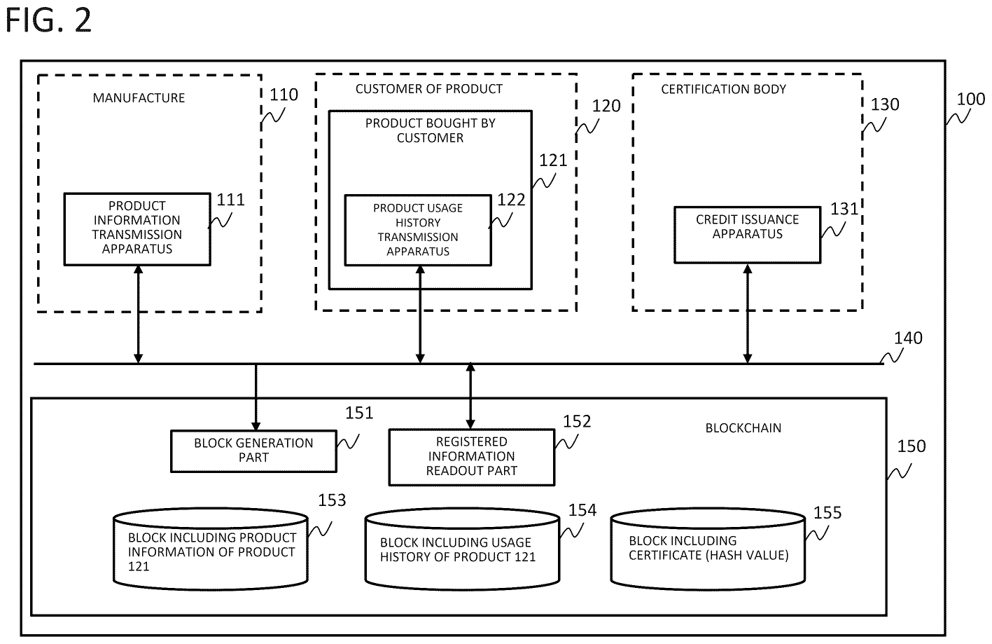

Next, an example of an outline of a configuration of a credit issuance system according to a first example embodiment of the present invention will be described with reference to drawings. FIG. 2 is a diagram illustrating an example of an outline of a configuration of a credit issuance system 100 according to a first example embodiment of the present invention. In FIG. 2, components denoted by the same reference signs as those in FIG. 1 indicate the same components, and description thereof will be omitted.

With reference to FIG. 2, the credit issuance system 100 includes a product information transmission apparatus 111 at a manufacturer 110 of a product, a product usage history transmission apparatus 122 provided in a product 121 bought by a customer 120 of a product, a credit issuance apparatus 131 at a certification body 130, a network 140 and a blockchain 150. Note, the product usage history transmission apparatus 122 may be configured to be provided outside a product 121 and connected to the product 121.

The blockchain 150 includes a block generation part 151 and a registered information readout part 152. The block generation part 151 generates a block when blockchain 150 receives product information of a product 121 transmitted from the product information transmission apparatus 111, product usage history of the product 121 transmitted from the product usage history transmission apparatus 122 and a certificate transmitted from the credit issuance apparatus 131. Then, the block generation part 151 registers a block 153 including the product information of a product 121, a block 154 including the product usage history of the product 121 and a block 155 including the certificate. Note, the block 153 including the product information of the product 121, the block 154 including the product usage history of the product 121 and the block 155 including the certificate are represented by different blocks because FIG. 2 conceptually shows information to be registered in a blockchain. However, a block including any one or more of product information, product usage history of a product and a certificate may be generated and registered. Furthermore, a block also including information other than product information, product usage history of a product, a certificate which are used in the credit issuance system 100 according to the first example embodiment of the present invention may be generated and registered.

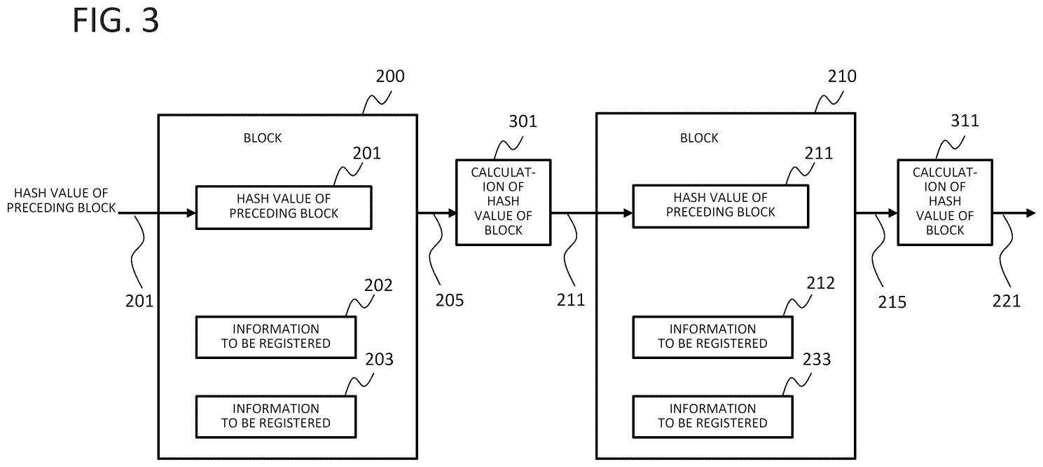

FIG. 3 is a diagram illustrating an example of an operation of a block generation part 151 of a blockchain 150 according to the first example embodiment of the present invention. The block generation part 151 generates a block 200 including one or more pieces of received information to be registered 202 and 203 and a hash value 201 of a preceding block (parent block). A hash value of the current block is calculated by performing a calculation of a hash value of the block 301 on information 205 including values based on the pieces of the information to be registered 202 and 203 and the hash value 201 of the preceding block. Note, the hash value of the current block is not necessarily calculated using all of the pieces of the information to be registered 202 and 203 and may be calculated using a value based on the pieces of the information to be registered 202 and 203. A calculated hash value 211 of the current block is not registered in the current block but is used for generating a next block 210 as a hash value 211 of a preceding block. As described above, it is possible to make up a blockchain by concatenating blocks which are difficult to be falsified, by calculating a hash value of the current block using a hash value of a preceding block in each block, whereby each block is possible to register information to be registered which is difficult to be falsified.

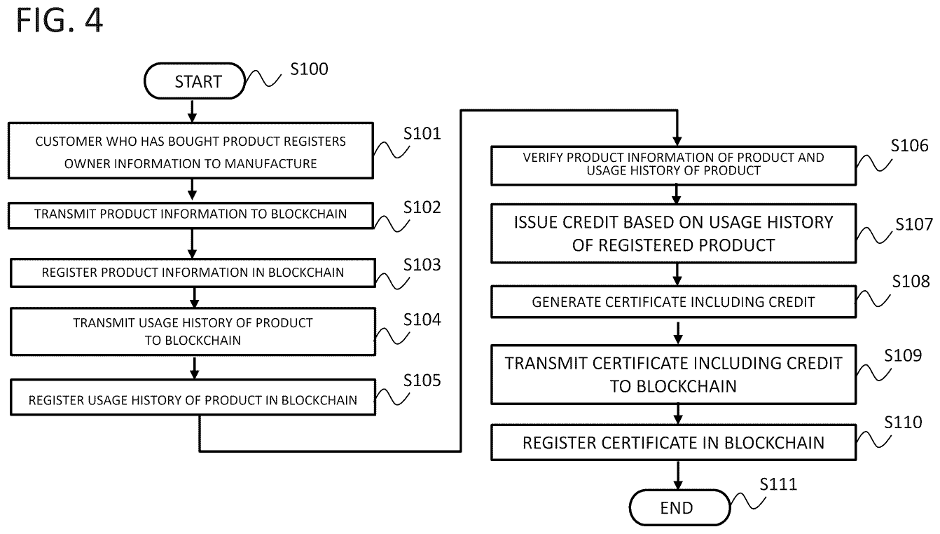

Next, an example of an outline of an operation of a credit issuance system 100 according to the first example embodiment of the present invention will be described. FIG. 4 is a flow chart illustrating an example of an outline of an operation of a credit issuance system 100 according to the first example embodiment of the present invention. The process starts at step S100.

At step S101, a customer who has bought a product 121 manufactured by a manufacture 110 registers owner information to the manufacture 110. Note, a product may be household appliances, such as an air-conditioner, a refrigerator, a washing machine, a television set, lighting equipment, and so on, a personal computer, an electric vehicle, or the like.

At step S102, a product information transmission apparatus 111 of the manufacture 110 transmits product information of the product 121 to a blockchain 150 via a network 140. The product information of the product 121 may include a specification concerning reduction of greenhouse gas emissions of the product 121, a serial number of the product 121, and owner information of the product 121. Note, the product information transmission apparatus 111 may transmit a specification concerning reduction of greenhouse gas emissions of the product 121 and a serial number of the product 121 as product information, and at a later time, when a customer who has bought a product registers owner information to the manufacture 110 the product information transmission n apparatus 111 may transmit product information including owner information of the product, again.

At step S103, when the blockchain 150 receives product information of the product 121 from the product information transmission apparatus 111, a block generation part 151 generates a block 153 including the product information of the product 121 and registers same in the blockchain 150.

Next, at step S104, a product usage history transmission apparatus 122 arranged in the product 121 which has been bought by the customer of the product automatically transmits usage history of the product 121 to the blockchain 150 via the network 140. The usage history of the product 121 may include a use state and a use time of the product 121 and a serial number of the product 121. Note, when an amount of emission reduction of green gas due to introduction of the product is prescribed in a product specification of a product 121, the usage history of the product 121 may not include a use state of the product 121 but may include a use time of the product 121 and a serial number of the product 121. Note, transmission of the usage history of the product 121 may performed by the product usage history transmission apparatus 122 which is made up by a hardware such as integrated circuit (IC) and so on that is difficult to be falsified provided in the product 121 in such way that a use state and a use time of the product 121 and a serial number of the product 121 are obtained and automatically transmitted, whereby human intervention may be prevented and falsification of information to be transmitted may be prevented.

At step S105, when the blockchain 150 receives the product usage history of the product 121 from the product usage history transmission apparatus 122, the block generation part 151 generate a block 154 including the usage history of the product 121 and registers same in the blockchain 150. In a case where both the product information of the product 121 and the usage history of the product 121 include a serial number of the product 121, it is possible to associate the product information of the product 121 registered in the block 153 including the product information and the usage history of the product 121. At step 106, a credit issuance apparatus 131 of a certification body 130 verifies the product information of the product 121 registered in the blockchain 150 and the usage history of the product 121 registered in the blockchain 150, via the network. As to verification of the usage history, for example, it is verified that the usage history of the product 121 corresponds to the product information of the product 121 by obtaining a serial number of a product 121 included in the block 154 containing the usage history of the product 121 and a serial number of a product 121 included in the block 153 containing the product information of the product 121.

At step S107, a credit issuance apparatus 131 at a certification body 130 issues a credit based on the verified usage history. At step S106, it has been verified that the usage history of the product 121 is the usage history of which product. Therefore, it is possible to obtain a value concerning actual reduction of greenhouse gas emissions from a specification concerning reduction of greenhouse gas emissions of the product 121 and a use state and a use time of the product 121, whereby it is possible to issue a credit based on the value. Note, in a case where an amount of emission reduction of green gas due to introduction of the product is prescribed in a product specification of a product, it is possible to obtain a value concerning actual reduction of greenhouse gas emissions from a use time of the product 121 and it is possible to issue a credit based on the value.

At step S108, the credit issuance apparatus 131 at the certification body 130 generates a certificate including the credit. The certificate may include the credit, the serial number of the product 121, and a hash value (or a digital signature by a private key of the certification body 130 which can be decrypted by a public key of the certification body 130) thereof. Furthermore, the certificate may include the credit, the serial number of the product 121, owner information of the product, and a hash value (or digital signature) thereof. As an example, the credit may be a J-credit.

At step S109, the credit issuance apparatus 131 at the certification body 130 transmits the certificate including the issued credit to the blockchain 150.

At step S110, when the blockchain 150 receives the certificate from the credit issuance apparatus 131, the block generation part 151 generates a block 155 including the certificate and registers same in the blockchain 150. The process ends at step S111.

According to the first example embodiment of the present invention, it is possible to provide a credit issuance system which contributes to be able to easily utilize a credit in small lot because usage history of a product, such as home appliance, bought by a customer of the product is automatically registered in a blockchain and a certificate including the credit issued based on product information and usage history of the product is registered in the blockchain.

Furthermore, according to the first example embodiment of the present invention, there is an effect that a demand for a product with high emission reduction effect of green gas is raised by the credit issuance system 100. In addition, because a manufacturer can collect usage history of a product which is registered on a blockchain, the manufacturer makes use of it for development of a subsequent product.

### Second Example Embodiment

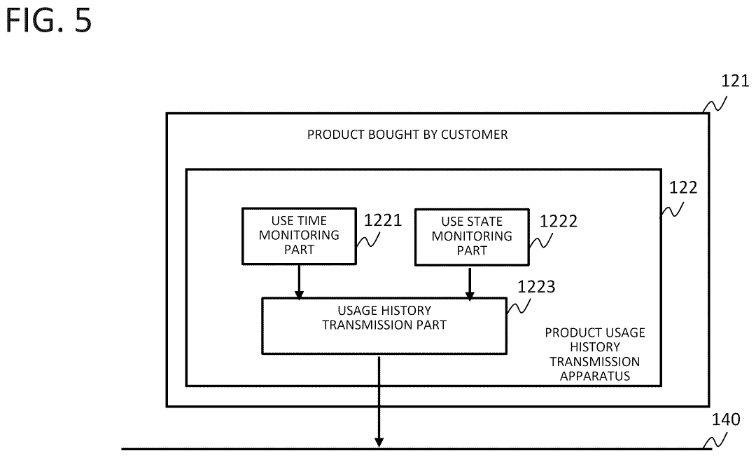

Next, a second example embodiment of the present invention will be described with reference to drawings. FIG. 5 is a diagram illustrating an example of a configuration of a product usage history transmission apparatus according to the second example embodiment of the present invention. In FIG. 5, components denoted by the same reference numerals as those in FIG. 2 indicate the same components, and description thereof will be omitted.

With reference to FIG. 5, for example, a product usage history transmission apparatus 122 which is made up by a hardware such as integrated circuit (IC) and so on that is difficult to be falsified is provided in a product 121 bought by a customer 120 of the product. The product usage history transmission apparatus 122 includes a use time monitoring part 1221, a use state monitoring part 1222, and a usage history transmission part 1223. The use time monitoring part 1221 monitors time during which the product 121 is being used. The use state monitoring part 1222 monitors a state of the product 121 being used. For example, in a case where cooling operation of an air conditioner is monitored, the use state monitoring part 1222 monitors whether the air conditioner is under cooling operation or pausing operation during a power-on state. The use time monitoring part 1221 monitors an operation time of the air conditioner during the cooling operation. The usage history transmission part 1223 automatically transmits the state monitored by the use state monitoring part 1222 and the operation time monitored by the use time monitoring part 1221 to a blockchain 150 via a network 140. Note, in a case where an amount of emission reduction of green gas due to introduction of the product is prescribed in a product specification of a product, the usage history transmission part 1223 may transmits a total of operation times monitored by the use time monitoring part 1221 to a blockchain 150 via a network 140. Note, as to a transmission interval, at a predetermined time interval, a total of operation times during the time interval may be transmitted by the use time monitoring part 1221. Alternatively, a total of operation times may be transmitted to a blockchain 150 via a network 140 every time when the total of operation times monitored by the use time monitoring part 1221 reaches a predetermined value.

According to the product usage history transmission apparatus 122 of the second embodiment of the present invention, it is possible to safely and automatically transmit a usage history of a product to a blockchain 150 while preventing human intervention.

### Third Example Embodiment

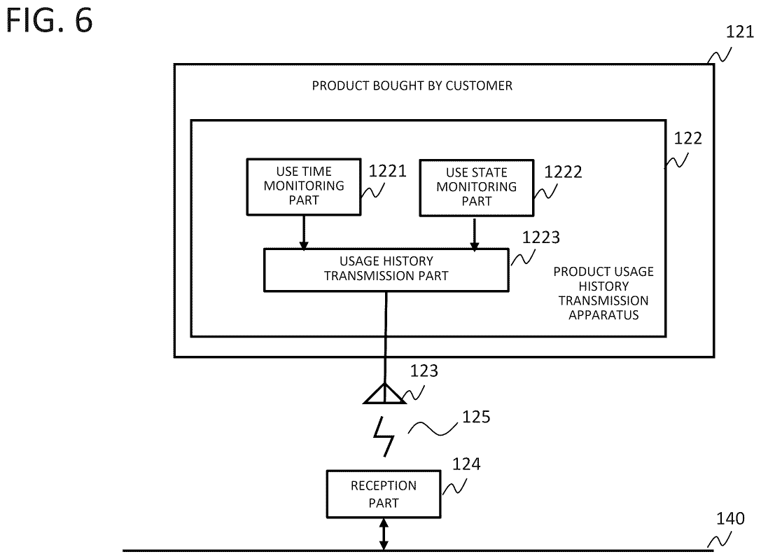

Next, a third example embodiment of the present invention will be described with reference to drawings. FIG. 6 is a diagram illustrating an example of a configuration of a product usage history transmission apparatus according to a third example embodiment of the present invention. In FIG. 6, components denoted by the same reference numerals as those in FIG. 5 indicate the same components, and description thereof will be omitted.

With reference to FIG. 6, for example, a product usage history transmission apparatus 122 which is made up by a hardware such as integrated circuit (IC) and so on that is difficult to be falsified is provided in a product 121 bought by a customer 120 of the product. The product usage history transmission apparatus 122 includes a use time monitoring part 1221, a use state monitoring part 1222, and a usage history transmission part 1223. The use time monitoring part 1221 and the use state monitoring part 1222 respectively perform the same operations as those performed by the use time monitoring part 1221 and the use state monitoring part 1222 in the second example embodiment. The usage history transmission part 1223 includes a wireless transmission part 123, and automatically transmits a use state monitored by the use state monitoring part 1222 and an operation time monitored by the use time monitoring part 1221 to a reception pat 124 connected to a network 140 via a wireless connection 125. When the reception pat 124 receives the monitored use state and the monitored operation time, the reception pat 124 automatically transmits the monitored operation time to the blockchain 150 via the network 140. Note, as a wireless connection 125, short range wireless communication technologies such as Bluetooth (a registered trademark) and so on may be used or a mobile wireless communication system may be used. In a case where a mobile wireless communication system is used, by installing a product usage history transmission apparatus 122 according to the third example embodiment of the present invention on an electrical vehicle and so on, a monitored use state and a monitored operation time can be automatically transmitted by a base station as a reception part 124 connected to a network 140 to a blockchain 140 via the network 140. Note, in a case where an amount of emission reduction of green gas due to introduction of the product is prescribed in a product specification of a product, the usage history transmission part 1223 may transmit a total of operation times monitored by the use time monitoring part 1221 to a blockchain 150 via a network 140. Note, as to a transmission interval, at a predetermined time interval, a total of operation times during the time interval may be transmitted by the use time monitoring part 1221. Alternatively, a total of operation times may be transmitted to a blockchain 150 via a network 140 every time when the total of operation times monitored by the use time monitoring part 1221 reaches a predetermined value.

According to the product usage history transmission apparatus 122 and the reception pat 124 of the third embodiment of the present invention, it is possible to safely and automatically transmit a usage history of a product to a blockchain 150 while preventing human intervention in a case where the product 121 bought by the customer 120 of the product is within a radio communication area of the reception part 124. As a result, it is possible to allow an installation location of the product 121 bought by the customer 120 of the product to have a flexibility. Furthermore, in a case where a mobile wireless communication system is used, by installing a product usage history transmission apparatus 122 according to the third example embodiment of the present invention on an electrical vehicle and so on, it is possible to safely and automatically transmit a usage history of the electrical vehicle to the blockchain 150.

### Fourth Example Embodiment

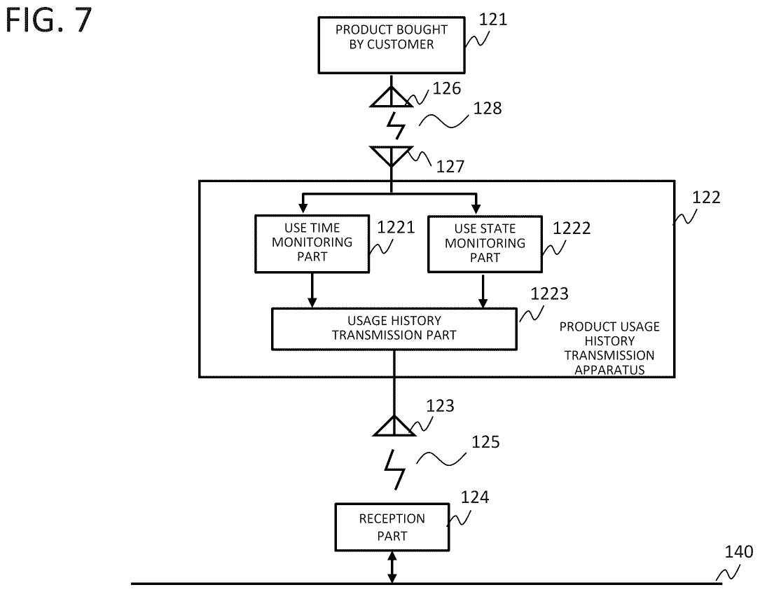

Next, a fourth example embodiment of the present invention will be described with reference to drawings. FIG. 7 is a diagram illustrating an example of a configuration of a product usage history transmission apparatus according to a fourth example embodiment of the present invention. In FIG. 7, components denoted by the same reference numerals as those in FIG. 6 indicate the same components, and description thereof will be omitted.

With reference to FIG. 7, as to a product usage history transmission apparatus 122 according to a fourth example embodiment of the present invention, it is configured that a product usage history transmission apparatus 122 provided in a product 121 bought by a customer 120 of the product according to the third example embodiment is arranged outside the product 121 bought by the customer 120 of the product, a wireless transmission part 126 is provided in the product 121 bought by the customer 120 of the product, a wireless reception part 127 is provided in the product usage history transmission apparatus 122, and the product usage history transmission apparatus 122 and the product 121 is connected by the wireless transmission part 126, the wireless reception part 127 and a wireless connection 128.

As an example, in a case where a mobile wireless communication system is used for a wireless connection 125 between a wireless transmission part 123 and a reception pat 124 and short range wireless communication technologies such as Bluetooth (a registered trademark) and so on may be used for a wireless connection 128 between the wireless transmission part 126 of the product 121 and the wireless reception part 127 of the product usage history transmission apparatus 122, the product usage history transmission apparatus 122 according to the fourth example embodiment of the present invention can be made up by a smart phone, a tablet terminal or the like on which an application that can transmit a usage history of a product is installed.

According to the product usage history transmission apparatus 122 of the fourth example embodiment of the present invention, by making up the product usage history transmission apparatus 122 using a smartphone, a tablet terminal, or the like, when a customer 120 of a product purchases a product 121, the credit issuance system 100 can be used with only a smartphone, a tablet terminal, or the like. As a result, according to the product usage history transmission apparatus 122 according to the fourth embodiment of the present invention, it is possible to provide the product usage history transmission apparatus 122 of a credit issuance system which contributes to be able to easily utilize a credit in small lot.

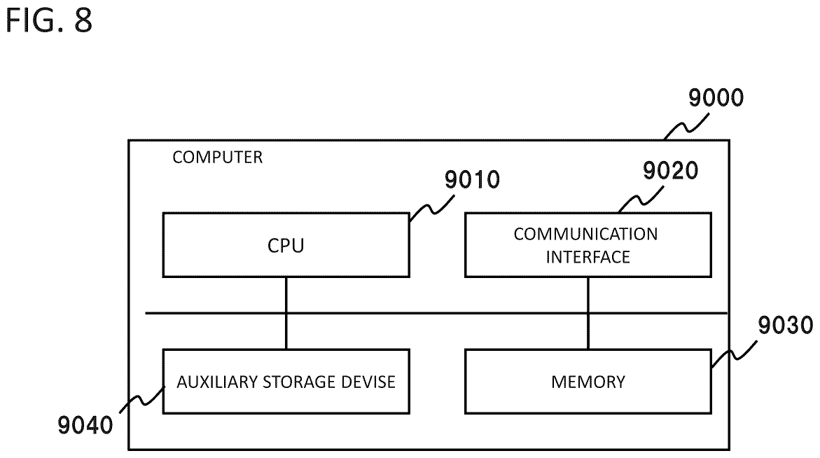

In addition, the procedures described in the above example embodiment and the first to fourth example embodiments can each be realized by a program causing a computer (9000 in FIG. 8) functioning as individual parts of the credit issuance system 100 or the product usage history transmission apparatus 122 to realize the functions as each part of the credit issuance system 100 or the product usage history transmission apparatus 122. For example, this computer is configured to include a CPU (Central Processing Unit) 9010, a communication interface 9020, a memory 9030, and an auxiliary storage device 9040 in FIG. 8. That is, the CPU 9010 in FIG. 8 executes a program as described above and performs processing for updating various calculation parameters stored in the auxiliary storage device 9040 or the like.

The memory 9030 is a RAM (Random Access Memory) or a ROM (Read-Only Memory), and so on.

That is, the individual parts (processing means, functions) of the credit issuance system 100 or the product usage history transmission apparatus 122 in the example embodiment and the first to fourth example embodiments as described above can each be realized by a computer program that causes a processor of the computer to execute the corresponding processing described above by using corresponding hardware.

Finally, suitable modes of the present invention will be summarized.

[Mode 1] (See the credit issuance system according to the above first aspect)

### [Mode 2]

In the credit issuance system according to mode 1, it is preferable that the product information includes a specification related to emission reduction of green gas of the product, a serial number of the product, and information of an owner of the product.

### [Mode 3]

In the credit issuance system according to mode 2, it is preferable that the usage history of the product includes a product use time and a serial number of the product.

### [Mode 4]

In the credit issuance system according to mode 1, it is preferable that the certificate includes the credit, a serial number of the product, and a hash value thereof.

### [Mode 5]

(See the product usage history transmission apparatus according to the above second aspect)

### [Mode 6]

(See the credit issuance method according to the above third aspect)

### [Mode 7]

In the credit issuance method according to mode 6, it is preferable that the product information includes a specification related to emission reduction of green gas of the product, a serial number of the product, and information of an owner of the product.

### [Mode 8]

In the credit issuance method according to mode 6, it is preferable that the usage history of the product includes a product use time and a serial number of the product.

### [Mode 9]

In the credit issuance method according to mode 6, it is preferable that the certificate includes the credit, a serial number of the product, and a hash value thereof.

### [Mode 10]

(See the program according to the above fourth aspect)

The disclosure of each of the above PTLs and NPLs is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed.

### REFERENCE SIGNS LIST

100 credit issuance system
110 manufacture
111 product information transmission apparatus
120 customer of product
121 product
122 product usage history transmission apparatus
123 wireless transmission part
124 reception part
125 wireless connection
126 wireless transmission part
127 wireless reception part
128 wireless connection
130 certification body
131 credit issuance apparatus
140 network
150 blockchain
151 block generation part
152 registered information readout part
153 block including product information of product 121
154 block including usage history of product 121
155 block including certificate
200, 210 block
201, 211, 221 hash value of preceding block
202, 203, 212, 213 information to be registered
205, 215 information including hash value 201 of preceding block
301, 311 calculation of hash value of block
1221 use time monitoring part
1222 use state monitoring part
1223 usage history transmission part
9000 computer
9010 CPU
9020 communication interface
9030 memory
9040 auxiliary storage device

What is claimed is:

1. A credit issuance system, comprising:
a product information transmission apparatus which comprises:
at least a first processor; and
a first memory in circuit communication with the first processor,
wherein the first processor is configured to execute program instructions stored in the memory to perform:
transmitting product information of a product via a network to a blockchain;
a product usage history transmission apparatus which comprises: at least a second processor; and
a second memory in circuit communication with the second processor,
wherein the second processor is configured to execute program instructions stored in the memory to perform:
automatically transmitting a usage history of the product via the network to the blockchain; and
a credit issuance apparatus which comprises:
at least a third processor; and
a third memory in circuit communication with the third processor,
wherein the third processor is configured to execute program instructions stored in the memory to perform:
verifying the product information of the product registered in the blockchain and the usage history of the product registered in the blockchain, via the network, issuing a credit used for a carbon offset based on the verified usage history, generating a certificate including the credit, and transmitting the certificate to the blockchain,
wherein the blockchain comprises:
at least a fourth processor; and
a fourth memory in circuit communication with the fourth processor, and
wherein the fourth processor is configured to execute program instructions stored in the memory to perform:
generating a block when the blockchain receives the product information of the product, the usage history of the product, or the certificate, and registering same in the blockchain.

2. The credit issuance system according to claim 1,
wherein the product information includes a specification related to emission reduction of green gas of the product, a serial number of the product, and information of an owner of the product.

3. The credit issuance system according to claim 1,
wherein the usage history of the product includes a product use time and a serial number of the product.

4. The credit issuance system according to claim 1,
wherein the certificate includes the credit, a serial number of the product, and a hash value thereof.

5. A product usage history transmission apparatus which comprises:
at least a processor; and
a memory in circuit communication with the processor,
wherein the processor is configured to execute program instructions stored in the memory to perform:
transmitting usage history of a product to a blockchain via a network.

6. A credit issuance method, comprising:
transmitting product information of a product via a network to a blockchain, by a product information transmission apparatus;
generating a block when the product information of the product is received and registering same in the blockchain, by the blockchain;
a step of automatically transmitting a usage history of the product via the network to the blockchain, by a product usage history transmission apparatus;
generating a block when the usage history of the product is received and registering same in the blockchain, by the blockchain;
verifying the product information of the product registered in the blockchain and the usage history of the product registered in the blockchain, via the network, issuing a credit used for a carbon offset based on the verified usage history, generating a certificate including the credit, and transmitting the certificate to the blockchain, by a credit issuance apparatus, and
generating a block when the certificate is received and registers same in the blockchain, by the block chain.

7. The credit issuance method according to claim 6,
wherein the product information includes a specification related to emission reduction of green gas of the product, a serial number of the product, and information of an owner of the product.

8. The credit issuance method according to claim 6,
wherein the usage history of the product includes a product use time and a serial number of the product.

9. The credit issuance method according to claim 6,
wherein the certificate includes the credit, a serial number of the product, and a hash value thereof.

10. A computer-readable non-transitory recording medium recording a program, wherein the program causes a computer included in a product usage history transmission apparatus to perform a processing of:
transmitting a usage history of a product to blockchain via a network.

11. The product usage history transmission apparatus according to claim 5,
wherein the usage history of the product includes a product use time and a serial number of the product.

12. The medium according to claim 10,
wherein the usage history of the product includes a product use time and a serial number of the product.
